(19) United States
(12) Patent Application Publication
(10) Pub. No.: US 2003/0167884 A1
(43) Pub. Date: Sep. 11, 2003

(54) Grip adapted for use with double ended wrenches

(76) Inventor: Richard J. Macor, Asbury, NJ (US)

Correspondence Address: Proprietary Technologies, Inc., 26 Alpaugh Drive, Asbury, NJ, 08802-1213, US

(21) Appl. No.: 10/093,972

(22) Filed: Mar. 8, 2002

(51) Int. Cl. B25B 23/16

(52) U.S. Cl. 81/177.1

(57) ABSTRACT

A wrench grip is described for use with double-ended wrenches. The double-ended wrench is generally formed having an elongated central portion and two opposite enlarged ends, an upper area, a lower area and two side areas. The wrench grip includes an elongated, hollow body with two opposite ends and is adapted for attachment with the double-ended wrench and for movement thereon. The wrench grip is further formed to be positionable at each end of the double-ended wrench without being removed from the double-ended wrench. And, at least one end of the wrench grip is adapted for interaction with at least one area of the double-ended wrench whereby movement of the grip along the double-ended wrench is confined by the interaction, and, the interaction does not involve a side area of the double ended wrench.

### FIELD OF THE INVENTION

The present invention relates to hand tools, particularly a gripping means for double-ended wrenches.

### BACKGROUND OF THE INVENTION

The applicant is not aware of any prior art which directly relates to the present invention which is a movable, wrench grip for double-ended wrenches, except for U.S. Pat. Nos. 5,823,077 and, 6,092,442, both of which are inventions by the inventor herein. Referring to these issued patents, applicant has disclosed and claimed a movable, gripping means for double-ended wrenches. Some preferred embodiments included a seam extending the length of the grip to facilitate attachment and detachment with a double-ended wrench. Such a grip embodiment was easy to install upon a double-ended wrench, however, it had a tendency to spread apart at the seam when pressed up against a wrench head (relied upon to confine movement of the grip.) When the grip seam spreads apart at one end, the grip becomes distorted and unintentional movement may occur. Subsequently, there is a need to improve upon the grip which is adapted for use with double ended wrenches. There is a need to configure a gripping means which does not spread apart at the seam, and/or distort while being pulled or pressed against a wrench head or end of a double-ended wrench.

### SUMMARY OF THE INVENTION

The present invention comprises a wrench grip for use with double-ended wrenches. The double-ended wrench is generally formed having an elongated central portion and two opposite enlarged ends, an upper area, a lower area and two side areas. The wrench grip includes an elongated, hollow body with two opposite ends, and is adapted for attachment with the double-ended wrench and for movement thereon. The wrench grip is further formed to be positionable at each end of the double-ended wrench without being removed from the double-ended wrench. At least one end of the wrench grip is adapted for interaction with at least one area of the double-ended wrench whereby movement of the grip along the double-ended wrench is confined by the interaction. And further, the interaction does not involve a side area of the double ended wrench.

The present invention has been developed recognizing the need to configure a gripping means which has at least one seam and is adapted for use with double-ended wrenches. The present invention has been further developed recognizing the need to configure a gripping means that does not spread apart at the seam, and/or distort while being pulled or pushed against an area of the wrench relied upon to confine movement of the grip upon the double-ended wrench.

Accordingly, it is an important objective of the present invention that it be adapted for used with double-ended wrenches.

It is another important objective of the present invention that it be configured with at least one seam to facilitate attachment and detachment with a double-ended wrench.

It is another important objective of the present invention that it be configured for interaction with the double-ended wrench to confine movement of the grip upon the wrench, and that the interaction does not spread the seam and/or distort the grip.

It is yet another objective of the present invention that it be commercially viable, simple in design, and cost efficient to manufacture.

### BRIEF DESCRIPTION OF THE DRAWINGS

FIG. 1 shows a top plan view of a prior art double-ended wrench and wrench grip; and,

FIG. 2 shows a top plan view of the double-ended wrench and grip shown in FIG. 1, with the wrench grip shown in a cross-section view; and,

FIG. 3 shows a top, cross-section view of a present invention, movable wrench grip installed upon a double-ended wrench shown in a top plan view; and,

FIG. 4 shows a side, cross-section view a present invention, movable wrench grip installed upon a double-ended wrench which is shown in a side, cut view; and,

FIG. 5 shows a side, cross-section view of the present invention, movable wrench grip and wrench shown in FIG. 4, but with the wrench shown here in a different side, cut view.

### DETAILED DESCRIPTION OF THE DRAWINGS

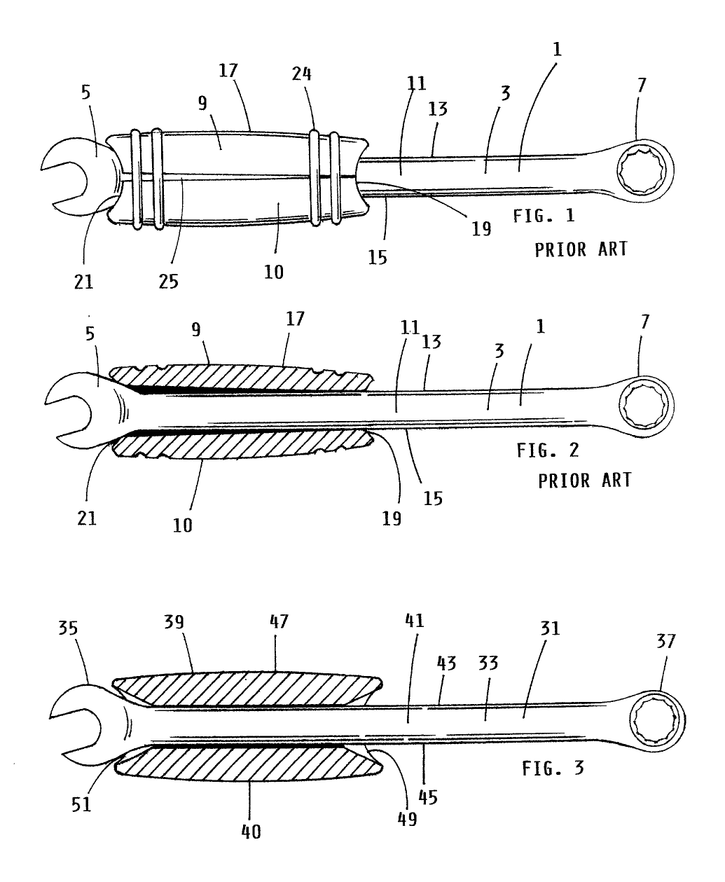

Referring now to the drawings which are for the purpose of illustrating preferred embodiments of the present invention and not for the purpose of limiting same, FIG. 1 shows a top plan view of a prior art, double-ended wrench 1 and wrench grip 17. Wrench 1 has an elongated central portion 3 and enlarged ends including open-ended wrench head 5 and box-ended wrench head 7. Wrench 1 has an upper area 11, a lower area not seen in this view and side areas 13 and 15. Gripping means 17 is Installed upon wrench 1 and adapted to be positionable at each end of double-ended wrench 1 and comprises two halves 9 and 10 which are separated by seam 25. The halves 9 and 10 of grip 17 are held together frictionally upon wrench 1 by four elastic bands, one of which is represented by band 24. Grip end 21 of gripping means 17 is interacting and touching side areas 13 and 15 of the enlarged end of wrench 1 at wrench head 5 which confines movement of grip 17 at that end of the wrench 1 as shown. The interaction of grip end 21 with wrench side areas 13 and 15 prevents grip 17 from moving off of wrench 1, however, the interaction causes the grip halves to spread apart at seam 25 as shown, which can create unintentional movement of grip 17 on wrench 1. This interaction also causes grip 17 to become distorted upon wrench 1 and seam 25 to expand as shown which is undesirable and may compromise the function of grip 17 on wrench 1. When referring to the various areas of a double-ended wrench described herein, the top area generally refers to an area seen in a top view; and, the lower area generally refers to an area seen in a lower view, and the side areas generally refer an area seen in a right and/or left side view. The enlarged end of a wrench generally refers to the wrench head and/or an area generally enlarged and adjacent to a wrench head. A grip end shall be defined herein as an area of the grip end seen from an end view which may contact and interact with an area of a wrench.

FIG. 2 shows a top plan view of the double-ended wrench 1 and gripping means 17 shown in FIG. 1, with the gripping means 17 shown in a cross-section view. Here it can be seen that grip end 21 of gripping means 17 is contacting the side areas 13 and 15 of wrench head 5. Grip end 21 is making contact and interacting with side areas 13 and 15 of wrench head 5. Note that the ends of wrench 1 (wrench heads 5 and 7) are enlarged relative to the elongated central portion 3 of wrench 1. If a gripping means which is adapted for use with double-ended wrenches relies upon the enlarged ends of the wrench to confine movement, and the grip end contacts and interacts with the side areas of an enlarged end of the wrench as defined herein, generally, the grip becomes distorted and spread apart at the seam. Such interaction between wrench and grip is undesirable and compromises the function of the grip upon the wrench.

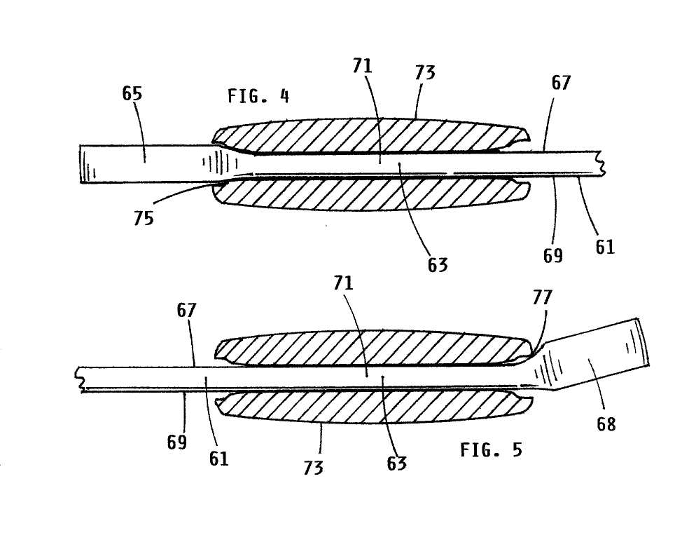

FIG. 3 shows a top, cross-section view of a present invention, movable wrench grip installed upon a double-ended wrench shown in a top plan view. Double-ended wrench 31 has an elongated central portion 33 and enlarged ends including open-ended wrench head 35 and box-ended wrench head 37. Wrench 31 has an upper area 41, a lower area not seen in this view and side areas 43 and 45. Gripping means 47 is Installed upon wrench 31 and adapted to be positionable at each end of double-ended wrench 31 and comprises two halves 39 and 40. In this view, grip 47 has been moved as far to the end of wrench 31 as possible, and grip 47 has been contained or stopped by an interaction between wrench and grip proximate wrench head 35. To contain movement of gripping means 47 at one end of wrench 31, contact occurs between grip end 51 and the upper and/or lower areas of wrench 31 in the proximate area of wrench head 35. Alternatively, to contain movement of gripping means 47 at the other end of wrench 31, contact occurs between grip end 49 and the upper and/or lower areas of wrench 31 in the proximate area of wrench head 37. Therefore, movement of grip 47 on wrench 31 is contained without relying upon the side areas 43 and 45 of wrench 31 as shown. In other words, in order to confine the movement of grip 47 at one end of the wrench, grip end portion 51 of gripping means 47 does not interact with and contact the side areas 43 and 45 of the enlarged end of wrench 31 at wrench head 35. Instead, grip end 51 contacts and interacts with an upper and/or lower area of wrench 31 at wrench head 35 to contain movement of the grip at that end of wrench. Likewise, in order to confine the movement of grip 47 at the other end of the wrench, grip end 49 of gripping means 47 does not interact with and contact the side areas 43 and 45 of the enlarged end of wrench 31 at wrench head 37. Instead, grip end 49 contacts and interacts with an upper and/or lower area of wrench 31 proximate wrench head 37 to contain movement of the grip at that end of the wrench. This may be better understood in the following FIGS. 4 and 5.

FIG. 4 shows a side, cross-section view a present invention, movable wrench grip installed upon a double-ended wrench which is shown in a side, cut view. Here wrench 61 comprises elongated central portion 63 and two wrench heads with only wrench head 65 shown in this cut view. Wrench 61 also has an upper area 67, a lower area 69, and side areas of which left side area 71 is shown in this view. It can be seen that grip end 75 of gripping means 73 is making contact and interacting with both upper and lower areas 67 and 69 respectively at an enlarged end of wrench 61, proximate wrench head 65. This contact and interaction between wrench and grip prevents grip 73 from being pulled off wrench 61, while also minimizing or eliminating the problems associated with the prior art grips, previously specified herein.

FIG. 5 shows a side, cross-section view of the present invention movable wrench grip and wrench shown in FIG. 4, but with the wrench shown in a different side, cut view. In this view, the other end of wrench 61 is shown with wrench grip 73 moved to that end of the wrench. Wrench 61 comprises elongated central portion 63 and two wrench heads with only wrench head 68 shown in this cut view. Wrench 61 also has an upper area 67, a lower area 69, and side areas of which left side area 71 is shown in this view. It can be seen that grip end 77 of gripping means 73 is making contact and interacting with both the upper area 69 at an enlarged end of wrench 61, proximate wrench head 68. This contact and interaction between wrench and grip prevents grip 73 from being pulled off wrench 61, while also minimizing or eliminating the problems associated with the prior art grips, previously specified herein.

Upon reading and understanding the specification of the present invention described above, modifications and alterations will become apparent to those skilled in the art. It is intended that all such modifications and alterations be included insofar as they come within the scope of the patent as claimed or the equivalence thereof.

Having thus described the invention, the following is claimed:

1. A wrench grip for use with double-ended wrenches, said double-ended wrench being generally formed having an elongated central portion and two opposite enlarged ends, said double-ended wrench further having an upper area, a lower area and two side areas; said wrench grip comprising an elongated, hollow body with two opposite ends, said wrench grip being adapted for attachment with said double-ended wrench and for movement thereon, said wrench grip being positionable at each end of said double-ended wrench without being removed from said double-ended wrench, and, at least one end of said wrench grip being adapted for interaction with at least one area of said double-ended wrench whereby movement of said wrench grip along said double-ended wrench is confined by said interaction, and further whereas, said interaction does not involve the side areas of said double ended wrench.

2. A wrench grip of claim 1, wherein said wrench grip is further adapted having at least one seam to facilitate attachment and detachment with said double ended wrench.

3. A wrench grip of claim 1, wherein an interaction occurring between said wrench and said grip involves an enlarged end of said double ended wrench.

4. A wrench grip of claim 1, wherein an interaction occurring between said wrench and said grip involves an upper area of said double ended wrench.

5. A wrench grip of claim 1, wherein an interaction occurring between said wrench and said grip involves a lower area of said double ended wrench.

6. A wrench grip of claim 2, wherein an interaction occurring between said wrench and said grip involves an enlarged end of said double ended wrench.

7. A wrench grip of claim 2, wherein an interaction occurring between said wrench and said grip involves an upper area of said double ended wrench.

8. A wrench grip of claim 2, wherein an interaction occurring between said wrench and said grip involves a lower area of said double ended wrench.

9. A wrench grip of claim 3, wherein an interaction occurring between said wrench and said grip involves an upper area of said double ended wrench.

10. A wrench grip of claim 3, wherein an interaction occurring between said wrench and said grip involves a lower area of said double ended wrench.

11. A wrench grip for use with double-ended wrenches, said double-ended wrench being generally formed having an elongated central portion an d two opposite enlarged ends, said double-ended wrench further having an upper area, a lower area and two side areas; said wrench grip comprising an elongated, hollow body with two opposite ends, said wrench grip being adapted for attachment with said double-ended wrench and for movement thereon, said wrench grip being positionable at each end of said double-ended wrench without being removed from said double-ended wrench, and, each end of said wrench grip being adapted for interaction with at least one area of said double-ended wrench whereby movement of said wrench grip along said double-ended wrench is confined by said interaction, and further whereas, said interaction does not involve the side areas of said double ended wrench.

12. A wrench grip of claim 11, wherein said wrench grip is further adapted having at least one seam to facilitate attachment and detachment with said double ended wrench.

13. A wrench grip of claim 11, wherein one end of said wrench grip is adapted for interaction with an enlarged end of said double ended wrench, and the other end of said wrench grip is adapted for interaction with the other enlarged end of said double ended wrench.

14. A wrench grip of claim 11, wherein an interaction occurring between said wrench and said grip involves an upper area of said double ended wrench.

15. A wrench grip of claim 11, wherein an interaction occurring between said wrench and said grip involves a lower area of said double ended wrench.

16. A wrench grip of claim 12, wherein one end of said wrench grip is adapted for interaction with an enlarged end of said double ended wrench, and the other end of said wrench grip is adapted for interaction with the other enlarged end of said double ended wrench.

17. A wrench grip of claim 12, wherein an interaction occurring between said wrench and said grip involves an upper area of said double ended wrench.

18. A wrench grip of claim 12, wherein an interaction occurring between said wrench and said grip involves a lower area of said double ended wrench.

19. A wrench grip of claim 13, wherein an interaction occurring between said wrench and said grip involves an upper area of said double ended wrench.

20. A wrench grip of claim 13, wherein an interaction occurring between said wrench and said grip involves a lower area of said double ended wrench.
